(19) United States
(12) Patent Application Publication
(10) Pub. No.: US 2023/0302811 A1
(43) Pub. Date: Sep. 28, 2023

(54) PRINT MATERIAL AMOUNTS IN PRINT CARTRIDGES

(71) Applicant: Hewlett-Packard Development Company, L.P., Spring, TX (US)

(72) Inventors: Jeffrey H Luke, Boise, ID (US); Gabriel Scott McDaniel, Boise, ID (US); Scott K Hymas, Boise, ID (US)

(21) Appl. No.: 18/023,370

(22) PCT Filed: Sep. 29, 2020
(86) PCT No.: PCT/US2020/053234

§ 371 Date: Feb. 26, 2023

(51) Int. Cl. B41J 2/175; G06T 7/00; G06T 7/60; G06K 15/02; G06K 15/00; G06F 3/12

(52) U.S. Cl. CPC B41J 2/17566; G06T 7/001; G06T 7/60; G06K 15/027; G06K 15/4075; G06F 3/121; G06F 3/1285; G06F 3/1235; G06T 2207/30144; G06T 2207/20081

(57) ABSTRACT

In some examples, a computing device can include a processing resource and a memory resource storing instructions to cause the processing resource to receive a diagnostic image including a print quality characteristic associated with a print cartridge of an imaging device, compare the print quality characteristic to a reference characteristic of a reference image, and determine whether an amount of print material in the print cartridge is less than a threshold amount in response to the comparison.

### BACKGROUND

Imaging systems, such as printers, copiers, etc., may be used to form markings on a physical medium, such as text, images, etc. In some examples, imaging systems may form markings on the physical medium by performing a print job. A print job can include forming markings such as text and/or images by transferring a print material (e.g., ink, toner, etc.) to the physical medium.

### BRIEF DESCRIPTION OF THE DRAWINGS

FIG. 1 is an example of a system for print material amounts in print cartridges consistent with the disclosure.

FIG. 2 is an example comparison of a print quality characteristic to a reference characteristic consistent with the disclosure.

FIG. 3 is an example of a computing device for print material amounts in print cartridges consistent with the disclosure.

FIG. 4 is a block diagram of an example system for print material amounts in print cartridges consistent with the disclosure.

FIG. 5 is an example of a method for print material amounts in print cartridges consistent with the disclosure.

### DETAILED DESCRIPTION

Imaging devices may include a supply of a print material. As used herein, the term “print material” refers to a substance which can be transported through and/or utilized by an imaging device. In some examples, print material can be, for instance, a material that when applied to a medium, can form representation(s) (e.g., text, images models, etc.) on the medium during a print job. Print material may include ink, toner, etc.

The print material can be deposited onto a physical medium. As used herein, the term “imaging device” refers to any hardware device with functionalities to physically produce representation(s) (e.g., text, images, models, etc.) on the medium. In some examples, a “medium” may include paper, photopolymers, plastics, composite, metal, wood, or the like. An imaging device can be a printing device (e.g., a printer). An imaging device can include printing, scanning, faxing, and/or other imaging device functionalities, and can perform print jobs when in receipt of a print job request from a computing device.

A device, such as a computing device, can generate a print job request and transmit the print job request to an imaging device. The imaging device can perform the print job according to the received print job request.

An imaging device can perform the print job by depositing print material onto a print medium from a print cartridge. As used herein, the term “print cartridge” refers to a container including print material. For example, the print cartridge can include toner that can be deposited onto a print medium to form text and/or images on the print medium during a print job.

Determining an amount of print material remaining in a print cartridge after performing print jobs can be useful for a user and/or supplier to know when to replace a print cartridge. For example, when a user and/or supplier knows an amount of print material remaining in a print cartridge is low, the user may order another print cartridge and/or the supplier may supply another print cartridge prior o the print cartridge running out of print material.

In some approaches, a print cartridge may include a sensor to determine an amount of print material remaining in a print cartridge. However, a sensor can represent an additional cost, which can increase prices for print cartridges.

In some approaches, an imaging device can utilize a pixel counting method to determine an amount of print material remaining in a print cartridge. However, pixel counting methods may not be accurate for every imaging device. For example, a first imaging device located in an environment with a different temperature and/or humidity than a second imaging device may produce different determinations regarding the amount of print material remaining in the imaging devices respective print cartridges. In other words, a pixel counting method may not be able to account for certain environmental or other factors (e.g., temperature, humidity, variations in the print cartridges from manufacturing, etc.) that may affect print material deposition onto a medium.

Inaccuracies in determining an amount of print material remaining in a print cartridge can cause issues with respect to replacement of the print cartridge. For example, if a print cartridge is determined to be close to empty but is not, a replacement print cartridge may be shipped too early, resulting in a user replacing a print cartridge without utilizing all of the print material, which may result in a cost to a supplier. As another example, if a print cartridge is not determined to be close to empty but is, a replacement cartridge may be shipped too late, resulting in a user not being able to request print jobs to be performed by an imaging device, which can result in a negative user experience.

Print material amounts in print cartridges, according to the disclosure, can allow for a more accurate determination of print material in a print cartridge as compared with previous approaches. For example, evaluation of diagnostic images relative to a reference image can allow for a more accurate determination of an amount of print material in a print cartridge relative to pixel counting methods. Further, such evaluation of diagnostic images can be adjusted according to environmental or other factors such as temperature, humidity, and/or variations in the print cartridge from manufacturing, as well as adjusted using fleet data from other imaging devices. Determination of an amount of print material in a print cartridge in such a manner can allow for more accurate determinations without the use of an additional sensor, which can allow for users and/or suppliers to provide and/or replace print cartridges when appropriate.

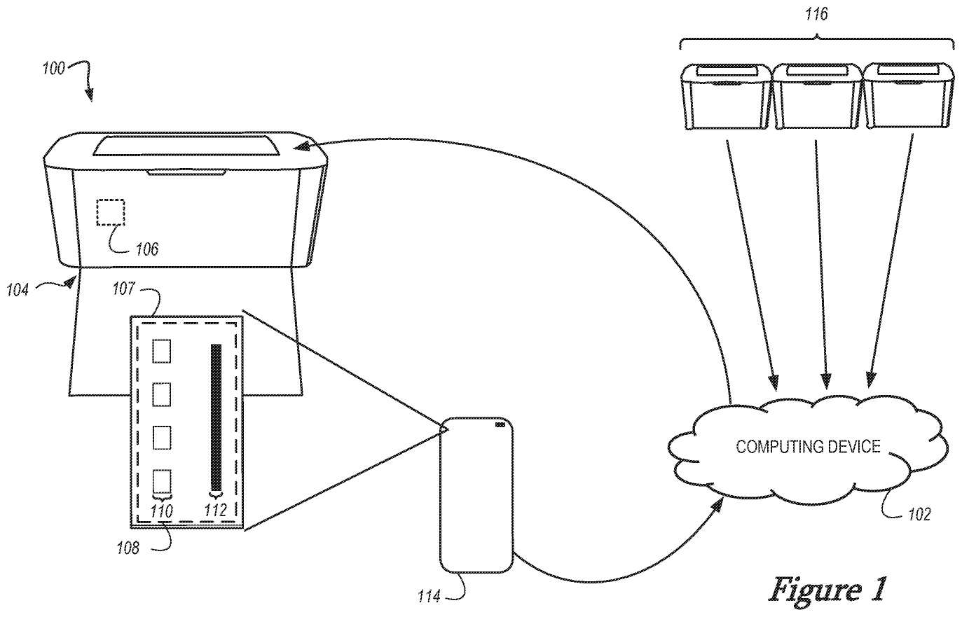

FIG. 1 is an example of a system 100 for print material amounts in print cartridges consistent with the disclosure. The system 100 can include a computing device 102, an imaging device 104, a fleet of imaging devices 105, a mobile device 114, and a print medium 107.

As illustrated in FIG. 1, the system 100 can include a computing device 102, an imaging device 104, and a mobile device 114. Utilizing the imaging device 104 and/or the mobile device 114, the computing device 102 can determine an amount of print material in a print cartridge 106 of the imaging device 104 by comparing a diagnostic image of the print medium 107 to a reference image of a reference medium, as is further described herein. This determination can be further supplemented utilizing the fleet of imaging devices 105, as is further described herein.

As described above, the computing device 102 can utilize a reference image of a reference medium. For example, the imaging device 104 can print a reference characteristic (e.g., not illustrated in FIG. 1) on a reference medium (e.g., not illustrated in FIG. 1) during a reference print job. As used herein, the term “reference characteristic” refers to a marking used as a point of comparison with respect to another marking. For example, the imaging device 104 can deposit print material onto a reference medium using the print cartridge 106 to form a reference characteristic (e.g., a reference mark). The reference characteristic can correspond to the print cartridge 106 when the print cartridge 106 is installed in the imaging device 104. That is, the reference characteristic can be a characteristic printed when the print cartridge 106 when the print cartridge 106 is new (e.g., full of print material).

In some examples, the mobile device 114 can take an image of the reference medium printed by the imaging device 104. As used herein, the term “take an image” refers to capturing a photograph (e.g., a digital photograph) by electronic photodetectors of an image capture device. For example, the mobile device 114 can utilize an image capture device (e.g., a camera) to capture an image of the reference medium printed by the imaging device 104. For instance, a user can capture the image using the mobile device 114.

As used herein, the term “mobile device” can include devices that are (or can be) carried and/or worn by the user. For example, mobile device 114 can be a phone (e.g., a smart phone), a tablet, a personal digital assistant (FDA), smart glasses, and/or a wrist-worn device (e.g., a smart watch), among other types of mobile devices.

The mobile device 114 can transmit the reference image including the reference characteristic to the computing device 102. The mobile device 114 can transmit the reference image via a wired or wireless connection. The wired or wireless network connection can be a network relationship that connects the mobile device 114 to the computing device 102. Examples of such a network relationship can include a local area network (LAN), wide area network (WAN), personal area network (PAN), a distributed computing environment (e.g., a cloud computing environment), storage area network (SAN), Metropolitan area network (MAN), a cellular communications network, Long Term Evolution (LTE), visible light communication (VLC), Bluetooth, Worldwide Interoperability for Microwave Access (WiMAX), infrared (IR) communication, Public Switched Telephone Network (PSTN), radio waves, and/or the Internet, among other types of network relationships,

As used herein, the term “computing device” refers to an electronic system having a processing resource, memory resource, and/or an application-specific integrated circuit (ASIC) that can process information. Examples of computing devices can include, for instance, a laptop computer, a notebook computer, a desktop computer, a server, networking equipment (e.g., router, switch, etc.), and/or a mobile device, among other types of computing devices.

In some examples, the imaging device 104 can scan an image of the reference medium printed by the imaging device 104. As used herein, the term “scan an image” refers to capturing an image using an optical device such as a charge-coupled device (CCD) or a contact image sensor (CIS). For example, the imaging device 104 may include scanning capabilities that can allow the imaging device 104 to scan the reference medium printed by the imaging device 104. For instance, the imaging device 104 and/or a user can manipulate the reference medium in order to allow the imaging device 104 to scan the image of the reference medium.

As print jobs by the imaging device 104 occur, the amount of print material in the print cartridge 106 can deplete. The reference characteristic can be compared against a print quality characteristic as the amount of print material in the print cartridge 106 depletes. For example, as the amount of print material in the print cartridge 106 depletes, similarities between the print quality characteristic and the reference characteristic can become less and less. The comparison between the reference characteristic and the print quality characteristic can be used to determine an amount of print material remaining in the print cartridge 106, as is further described herein.

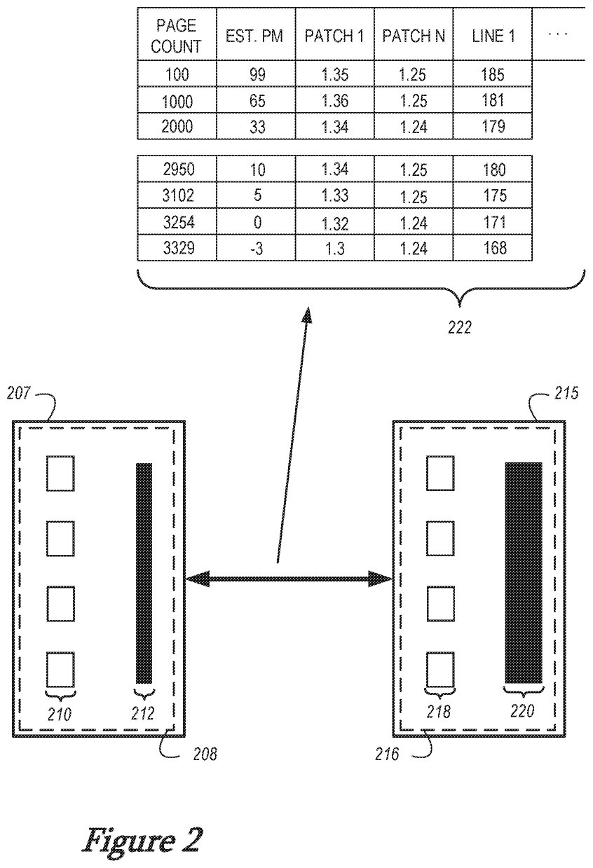

The computing device 102 can receive a diagnostic image including the print quality characteristic associated with the print cartridge 106 of the imaging device 104. As used herein, the term “diagnostic image” refers to a photograph of a print medium that includes a print quality characteristic. For example, the imaging device 104 may perform a print job including printing a print quality characteristic 108 on a print medium 107. As used herein, the term “print quality characteristic” refers to a marking to indicate an attribute that is used as a point of comparison with respect to another marking. For example, the print quality characteristic 108 can include attributes that can be compared against attributes included on the reference characteristic on a reference medium (e.g., as is further described in connection with FIG. 2). Attributes included on the print quality characteristic 108 can include a density level 110 and/or a line width 112, as is further described herein.

In some examples, the mobile device 114 can take an image of the print medium 107 printed by the imaging device 104, For example, the mobile device 114 can utilize an image capture device (e.g., a camera) to capture an image of the print medium 107 printed by the imaging device 104. For instance, a user can capture the image including the print quality characteristic 108 using the mobile device 114. The mobile device 114 can transmit the image including the print quality characteristic 108 of the print medium 107. Accordingly, the computing device 102 can receive the diagnostic image from the mobile device 114.

In some examples, the imaging device 104 can scan an image of the print medium 107 printed by the imaging device 104. For example, the imaging device 104 may include scanning capabilities that can allow the imaging device 104 to scan the print medium 107 printed by the imaging device 104, For instance, the imaging device 104 and/or a user can manipulate the print medium 107 in order to allow the imaging device 104 to scan the image of the print medium 107. Accordingly, the computing device 102 can receive the diagnostic image from the imaging device 104.

In some examples, the print quality characteristic 108 can include a density level 110. As used herein, the term “density level” refers to an amount of print material deposited onto a defined space. For example, the density level 110 can include a particular amount of print material that is deposited onto an area of the print medium 107, as illustrated in FIG. 1.

In some examples, the print quality characteristic 108 can include a line width 112. As used herein, the term “line width” refers to a dimension from one side of a printed line to another side of the printed line. For example, the line width 112 can be the width of a line printed on the print medium 107 by the imaging device.

The computing device 102 can compare the print quality characteristic 108 to a reference characteristic of a reference image, For example, the computing device 102 can compare the density level 110 and/or the line width 112 of the print medium 107 (e.g., transmitted to the computing device 102 via the diagnostic image) to a reference density level and/or a reference line width, respectively, of a reference image of a reference medium, as is further described herein.

In some examples, the computing device 102 can compare the density level 110 of the print medium 107 to a density level of a reference image of a reference medium. For example, the computing device 102 can compare the density level 110 to a density level of the reference image to determine whether the density level 110 has decreased relative to the density level of the reference image. Degradation of the density level 110 relative to the density level of the reference image can indicate, for example, that an amount of print material remaining in the print cartridge 106 may be low. For instance, a reduction by 0.15 density units may indicate an amount of print material in the print cartridge 106 is getting low and the print quality characteristic is (or may begin to) fade. Accordingly, correlation of the density level 110 relative to the density level of the reference image can allow the computing device 102 to determine an amount of print material remaining in the print cartridge 106.

While a reduction in a threshold of 0.15 density units is described above, examples of the disclosure are not so limited. For example, a reduction in any other defined amount of density units may indicate an amount of print material in the print cartridge 106 is getting low and the print quality characteristic is (or may begin to) fade. The threshold amount of density units may depend on a type of imaging device 104, the model of imaging device 104, the type of print cartridge 106, etc.

In some examples, the computing device 102 can compare the line width 112 of the print medium 107 to a reference line width of a reference image of a reference medium. For example, the computing device 102 can compare the line width 112 to a reference line width of the reference image to determine whether the line width 112 has decreased relative to the reference line width of the reference image. A decreasing line width 112 relative to the reference line width of the reference image can indicate, for example, that an amount of print material remaining in the print cartridge 106 may be low. For instance, a decrease in the line width 112 of 15% may indicate an amount of print material in the print cartridge 106 is getting low and the print quality characteristic is (or may begin to) fade. Accordingly, correlation of the line width 112 relative to the reference line width of the reference image can allow the computing device 102 to determine an amount of print material remaining in the print cartridge 106.

While a reduction in line width of 15% is described above, examples of the disclosure are not so limited. For example, a reduction in any other defined amount of line width may indicate an amount of print material in the print cartridge 106 is getting low and the print quality characteristic is (or may begin to) fade. The threshold amount of line width may depend on a type of imaging device 104, the model of imaging device 104, the type of print cartridge 106, etc.

The computing device 102 can determine whether an amount of print material in the print cartridge 106 is less than a threshold amount in response to the comparison of the print quality characteristic 108 to the reference characteristic. For example, the computing device 102 may determine above that 5% of the print material remains in the print cartridge 106. The computing device 102 can determine that the amount of print material remaining in the print cartridge 106 (e.g., 5%) is less than a threshold amount (e.g., 10%).

Although the threshold amount is described above as being 10% of print material remaining in the print cartridge 106, examples of the disclosure are not so limited. For example, the threshold amount can be lower than 10% or higher than 10% of print material remaining in the print cartridge 106. Further, the threshold amount can be modifiable.

In response to the amount of print material remaining in the print cartridge 106 being below a threshold amount, the computing device 102 can transmit a permission to the imaging device 104. As used herein, the term “permission” refers to an access detail authorizing a certain event to occur. For example, the computing device 102 can transmit a permission to the imaging device 104 to authorize the print cartridge 106 to be replaced. The permission can allow firmware of the imaging device 104 to detect a replacement print cartridge and/or allow the replacement print cartridge to deposit print material during a print job subsequent to the installation of the replacement print cartridge. When the replacement print cartridge is installed in the imaging device 104, the imaging device 104 can again print a reference characteristic (e.g., as described above) on a reference medium during a reference print job that corresponds to the replacement print cartridge.

In some examples, in addition to receiving the diagnostic image including the print quality characteristic 108, the computing device 102 can receive a first estimated amount of print material remaining in the print cartridge 106 from the imaging device 104. For example, the imaging device 104 can estimate an amount of print material remaining in the print cartridge 106, as is further described herein.

The imaging device 104 can estimate the first estimated amount of print material remaining in the print cartridge 106 by a pixel counting method. As used herein, the term “pixel counting” refers to a method of estimating an amount of print material remaining in a print cartridge by analyzing an amount of pixels printed on a print medium during a print job. For example, the imaging device 104 can estimate an amount of print material utilized during a print job by estimating an amount of pixels printed during a print job as well as utilizing an estimated amount of print material used per pixel. The imaging device 104 can transmit the estimated amount of print material remaining in the print cartridge 106 (e.g., determined via pixel counting) to the computing device 102.

As previously described above, the computing device 102 can determine a second estimated amount of print material remaining in the print cartridge 106 by comparing the print quality characteristic 108 to a reference characteristic of a reference image. For example, correlation of the print quality characteristic 108 relative to the reference image can allow the computing device 102 to determine the second estimated amount of print material remaining in the print cartridge 106.

As previously described above, imaging devices in certain locations may produce inaccurate estimations of print material remaining in a print cartridge due to environmental or other factors such as temperature, humidity, and/or variations in the print cartridge from manufacturing, etc. That is, the pixel counting method described above to determine the first estimated amount of print material remaining in the print cartridge 106 may include inaccuracies as a result of environmental or other factors. Accordingly, the computing device 102 can account for these inaccuracies using a correction factor, as is further described herein.

The computing device 102 can determine a correction factor by determining an error in the first estimated amount of print material using the second estimated amount of print material. As used herein, the term “correction factor” refers to a first quantity applied to a second quantity to increase the accuracy of the second quantity. As used herein, the term “error” refers to a deviation of an observed value of an element of a statistical sample from its theoretical value. The computing device 102 can determine the correction factor by determining an error in the first estimated amount of print material. For example, the computing device 102 can determine an error in the first estimated amount of print material by determining a deviation of the first estimated amount of print material from the second estimated amount of print material.

The computing device 102 can, accordingly, determine an amount of print material remaining in the print cartridge 106 based on the first estimated amount of print material (e.g., from the pixel counting method) and the second estimated amount of print material (e.g., from the comparison of the print quality characteristic 108 to the reference characteristic). For example, the computing device 102 can apply the correction factor to the first estimated amount of print material (e.g., from pixel counting) to determine a percentage of print material remaining in the print cartridge 106. For instance, utilizing Equation 1 below:

$$PMR = {EPM}_{1} + ( 100 - {EPM}_{1} ) \times \frac{CF}{100} \qquad Equation 1$$

where PMR is the percentage of print material remaining in the print cartridge 106, EPM1 is the first estimated amount of print material (e.g., from pixel counting), and CF is the correction factor (e.g., determined using the first estimated amount of print material and the second estimated amount of print material).

As described above, the computing device 102 can determine the amount of print material remaining in the print cartridge 106 by applying the correction factor to the first estimated amount of print material (e.g., from pixel counting via the imaging device 104). However, examples of the disclosure are not so limited. For example, the computing device 102 can determine the amount of print material remaining in the print cartridge 106 by applying the correction factor to the second estimated amount of print material (e.g., from the comparison of the print quality characteristic 108 to the reference characteristic), as is further described herein.

In some examples, the computing device 102 can determine a correction factor by determining an error in the second estimated amount of print material using the first estimated amount of print material. The computing device 102 can determine the correction factor by determining an error in the second estimated amount of print material. For example, the computing device 102 can determine an error in the second estimated amount of print material by determining a deviation of the second estimated amount of print material from the first estimated amount of print material.

The computing device 102 can, accordingly, determine an amount of print material remaining in the print cartridge 106 based on the second estimated amount of print material (e.g., from the comparison of the print quality characteristic 108 to the reference characteristic) and the first estimated amount of print material (e.g., from the pixel counting method), For example, the computing device 102 can apply the correction factor to the second estimated amount of print material (e.g., from the comparison of the print quality characteristic 108 to the reference characteristic) to determine a percentage of print material remaining in the print cartridge 106. For instance, utilizing Equation 2 below:

$$PMR = {EPM}_{2} + ( 100 - {EPM}_{2} ) \times \frac{CF}{100} \qquad Equation 2$$

where PMR is the percentage of print material remaining in the print cartridge 106, EPM2 is the second estimated amount of print material (e.g., from the comparison of the print quality characteristic 108 to the reference characteristic), and CF is the correction factor (e.g., determined using the second estimated amount of print material and the second estimated amount of print material). Such an approach may be utilized when a degree of accuracy from the pixel counting method from the imaging device 104 is sufficient and can allow the computing device 102 to tune print material amount determinations as further data (e.g., pixel counts, estimated print material amounts, etc.) is received from the imaging device 104 and/or the fleet of imaging devices 105.

The computing device 102 can determine whether the amount of print material in the print cartridge 106 is less than a threshold amount. For example, the computing device 102 can determine the amount of print material in the print cartridge 106 (e.g., utilizing Equation 1 as described above) to be 5%, and determine the amount of print material in the print cartridge 106 (e.g., 5%) is less than a threshold amount (e.g., 10%). In response to the amount of print material being below a threshold amount, the computing device 102 can transmit a permission to the imaging device 104 to allow the print cartridge 106 to be replaced. In response to the amount of print material being above the threshold amount, the computing device 102 can do nothing in order to allow the imaging device 104 to continue to utilize the remaining portion of the print material included in the print cartridge 106,

In some examples, in addition to utilizing the first and second estimated amounts of print material remaining in the print cartridge 106, the correction factor can be supplemented utilizing information from the fleet of imaging devices 105. The computing device 102 can determine a correction factor using the first estimated amount of print material, the second estimated amount of print material, and the imaging device fleet information from the fleet of imaging devices 105. As used herein, the term “imaging device fleet information” refers to information describing other imaging devices that may be of a same manufacturer, a same device model, a same manufacturer, a same manufacturing lot, same or similar usage conditions (e.g., environmental factors such as temperature, humidity, location, etc.), continuous image (contone) evaluation, a same print cartridge model, a same print cartridge manufacturing lot, component lot code, etc. For example, the computing device 102 can receive the imaging device fleet information from the fleet of imaging devices 105. Utilizing machine learning, the computing device 102 can determine print material consumption utilizing machine learning techniques from the imaging device fleet information. The computing device 102 can, accordingly, determine the correction factor by determining an error in the first estimated amount of print material by determining a deviation of the first estimated amount of print material from the second estimated amount of print material, as well as compensating utilizing the print material consumption determined from application of machine learning techniques to the imaging device fleet information. The computing device 102 can then apply the correction factor (that incorporates the print material consumption determined from the application of machine learning techniques to the imaging device fleet information) to the first estimated amount of print material (e.g., from pixel counting) to determine a percentage of print material remaining in the print cartridge 106.

Print material amounts in print cartridges according to the disclosure can allow for a more accurate prediction of print material amounts included in a print cartridge of an imaging device as compared with previous approaches. This can improve timing of print cartridge replacement, resulting in a supplier shipping a replacement print cartridge when appropriate (e.g., before the user runs out of print material in the print cartridge) in order to avoid a delay for a user requesting print jobs to be performed, which may lead to an increase in user satisfaction.

FIG. 2 is an example comparison of a print quality characteristic 208 to a reference characteristic 216 consistent with the disclosure. The print quality characteristic 208 can include a density level 210 and a line width 212. The reference characteristic 216 can include a density level 218 and a reference line width 220.

As illustrated in FIG. 2, the print quality characteristic 208 can be printed on a print medium 207. The print quality characteristic 208 can include a density level 210 and/or a line width 212. A mobile device can capture a diagnostic image of the print quality characteristic 208 and transmit the diagnostic image to a computing device. The computing device can compare the diagnostic image to a reference image,

The reference characteristic 216 can be printed on a print medium 215. For example, when a print cartridge is new (e.g., full of print material), an imaging device can print the reference characteristic 216 on the print medium 215 and a mobile device can capture a reference image of the reference characteristic 216 and transmit the reference image to the computing device for comparison against diagnostic images.

For example, the computing device can compare a density level 210 and/or a line width 212 included in the diagnostic image with a reference density level 218 and/or a reference line width 220 included in the reference image. The computing device can determine an amount of print material included in the print cartridge based on the comparison. Such comparisons with the reference image can be made with subsequent diagnostic images and can yield an image quality analysis 222, as is further described herein.

As illustrated in FIG. 2, comparison of a plurality of diagnostic images against a reference image can yield an image quality analysis 222. As used herein, the term “image quality analysis” refers to data describing comparisons of diagnostic images against a reference image. For example, a diagnostic image taken of a print quality characteristic 208 printed after 100 pages can provide information regarding a change in density units of a density level 210 relative to a density level 218, information regarding a change in line width 212 relative to a reference line width 220, and an estimated amount of print material remaining in the print cartridge (e.g., 99%).

The imaging device can perform subsequent print jobs to print further print quality characteristics for comparison against the reference characteristics as the imaging device is utilized for print jobs (e.g., and the amount of toner in the print cartridge is depleted). For example, a diagnostic image taken of a print quality characteristic printed after 2,000 pages compared with the reference image can allow for an estimated amount of print material remaining in the print cartridge to be 33% (e.g., utilizing techniques described herein). As another example, a diagnostic image taken of a print quality characteristic printed after 3,102 pages compared with the reference image can allow for an estimated amount of print material remaining in the print cartridge to be 5%. As previously described above, when the estimated amount of print material is below a threshold amount, the computing device can transmit a permission to the imaging device to allow the print cartridge to be replaced.

As illustrated in the image quality analysis 222, the imaging device can perform print jobs to print further print quality characteristics for comparison against the reference characteristic at a frequency that increases as the amount of print material remaining in the print cartridge decreases. This can be done to ensure a proper sampling rate to determine the amount of print material in the print cartridge is fast enough to detect when the amount of print material in the print cartridge is below the threshold amount.

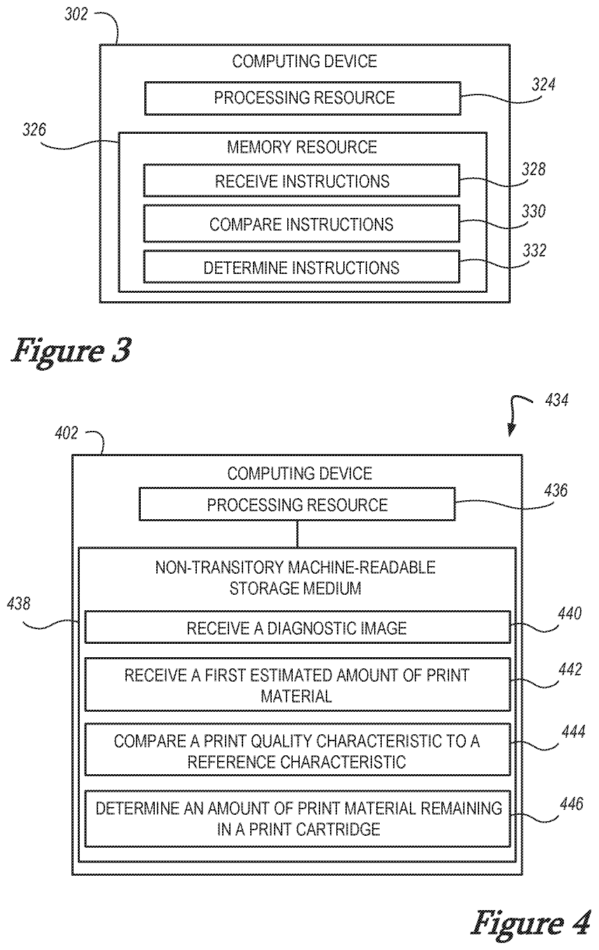

FIG. 3 is an example of a computing device 302 for print material amounts in print cartridges consistent with the disclosure. As described herein, the computing device 302 may perform functions related to print material amounts in print cartridges. Although not illustrated in FIG. 3, the computing device 302 may include a processor and a machine-readable storage medium. Although the following descriptions refer to a single processor and a single machine-readable storage medium, the descriptions may also apply to a system with multiple processors and multiple machine-readable storage mediums. In such examples, the computing device 302 may be distributed across multiple machine-readable storage mediums and across multiple processors. Put another way, the instructions executed by the computing device 302 may be stored across multiple machine-readable storage mediums and executed across multiple processors, such as in a distributed or virtual computing environment.

Processing resource 324 may be a central processing unit (CPU), a semiconductor-based microprocessor, and/or other hardware devices suitable for retrieval and execution of machine-readable instructions 328, 330, 332 stored in a memory resource 326. Processing resource 324 may fetch, decode, and execute instructions 328, 330, 332. As an alternative or in addition to retrieving and executing instructions 328, 330, 332, processing resource 324 may include a plurality of electronic circuits that include electronic components for performing the functionality of instructions 328, 330, 332.

Memory resource 326 may be any electronic, magnetic, optical, or other physical storage device that stores executable instructions 328, 330, 332, and/or data. Thus, memory resource 326 may be, for example, Random Access Memory (RAM), an Electrically-Erasable Programmable Read-Only Memory (EEPROM), a storage drive, an optical disc, and the like, Memory resource 326 may be disposed within computing device 302, as shown in FIG. 3. Additionally, memory resource 326 may be a portable, external or remote storage medium, for example, that causes computing device 302 to download the instructions 328, 330, 332 from the portable/external/remote storage medium.

The computing device 302 may include instructions 328 stored in the memory resource 326 and executable by the processing resource 324 to receive a diagnostic image including a print quality characteristic associated with a print cartridge of an imaging device. The print quality characteristic can include, for example, a density level and/or a line width printed on a physical medium. The diagnostic image can be a photograph taken of the print quality characteristic via an image capture device of a mobile device, in some examples.

The computing device 302 may include instructions 330 stored in the memory resource 326 and executable by the processing resource 324 to compare the print quality characteristic to a reference characteristic of a reference image. The reference image can be a photograph taken of the reference characteristic via an image capture device of a mobile device when the print cartridge is new (e.g., full of print material), in some examples. The reference characteristic can include a density level and/or a line width, For example, the computing device 302 can compare the density level and/or a line width of the print quality characteristic to the density level and/or reference line width of the reference characteristic. Based on the comparison, the computing device can determine an amount of print material in the print cartridge.

The computing device 302 may include instructions 332 stored in the memory resource 326 and executable by the processing resource 324 to determine whether an amount of print material in the print cartridge is less than a threshold amount in response to the comparison. In response to the amount of print material in the print cartridge being less than the threshold amount, the computing device 302 can transmit a permission to the imaging device to allow the print cartridge to be replaced.

FIG. 4 is a block diagram of an example system 434 for print material amounts in print cartridges consistent with the disclosure. In the example of FIG. 4, system 434 includes a computing device 402 including a processing resource 436 and a non-transitory machine-readable storage medium 438. Although the following descriptions refer to a single processing resource and a single machine-readable storage medium, the descriptions may also apply to a system with multiple processors and multiple machine-readable storage mediums. In such examples, the instructions may be distributed across multiple machine-readable storage mediums and the instructions may be distributed across multiple processors. Put another way, the instructions may be stored across multiple machine-readable storage mediums and executed across multiple processors, such as in a distributed computing environment.

Processing resource 436 may be a central processing unit (CPU), microprocessor, and/or other hardware device suitable for retrieval and execution of instructions stored in machine-readable storage medium 438. In the particular example shown in FIG. 4, processing resource 436 may receive, determine, and send instructions 440, 442, 444, 446. As an alternative or in addition to retrieving and executing instructions, processing resource 436 may include an electronic circuit comprising a number of electronic components for performing the operations of the instructions in machine-readable storage medium 438. With respect to the executable instruction representations or boxes described and shown herein, it should be understood that part or all of the executable instructions and/or electronic circuits included within one box may be included in a different box shown in the figures or in a different box not shown.

Machine-readable storage medium 438 may be any electronic, magnetic, optical, or other physical storage device that stores executable instructions. Thus, machine-readable storage medium 438 may be, for example, Random Access Memory (RAM), an Electrically-Erasable Programmable Read-Only Memory (EEPROM), a storage drive, an optical disc, and the like. The executable instructions may be “installed” on the system 434 illustrated in FIG. 4. Machine-readable storage medium 438 may be a portable, external or remote storage medium, for example, that allows the system 434 to download the instructions from the portable/external/remote storage medium. In this situation, the executable instructions may be part of an “installation package”.

Receive a diagnostic image instructions 440, when executed by a processor such as processing resource 436, may cause system 434 to receive a diagnostic image including a print quality characteristic associated with a print cartridge of an imaging device. The print quality characteristic can include, for example, a density level and/or a line width printed on a physical medium. The diagnostic image can be a photograph taken of the print quality characteristic via an image capture device of a mobile device, in some examples.

Receive a first estimated amount of print material instructions 442, when executed by a processor such as processing resource 436, may cause system 434 to receive a first estimated amount of print material remaining in the print cartridge from the imaging device. For example, the imaging device can perform pixel counting methods on the print quality characteristic to estimate the first amount of print material remaining in the print cartridge.

Compare a print quality characteristic to a reference characteristic instructions 444, when executed by a processor such as processing resource 436, may cause system 434 to compare the print quality characteristic to a reference characteristic of a reference image to determine a second estimated amount of print material remaining in the print cartridge. The reference image can be a photograph taken of the reference characteristic via an image capture device of a mobile device when the print cartridge is new (e.g., full of print material), in some examples, and can include a density level and/or a line width. The computing device 402 can compare the density level and/or a line width of the print quality characteristic to the density level and/or reference line width of the reference characteristic. Based on the comparison, the computing device can determine the second estimated amount of print material in the print cartridge.

Determine an amount of print material remaining in a print cartridge instructions 446, when executed by a processor such as processing resource 436, may cause system 434 to determine an amount of print material remaining in the print cartridge based on the first estimated amount of print material and the second estimated amount of print material. For example, the computing device 402 can determine a correction factor by determining an error in the first estimated amount of print material using the second estimated amount of print material and apply the correction factor to the first estimated amount of print material to determine the amount of print material remaining in the print cartridge.

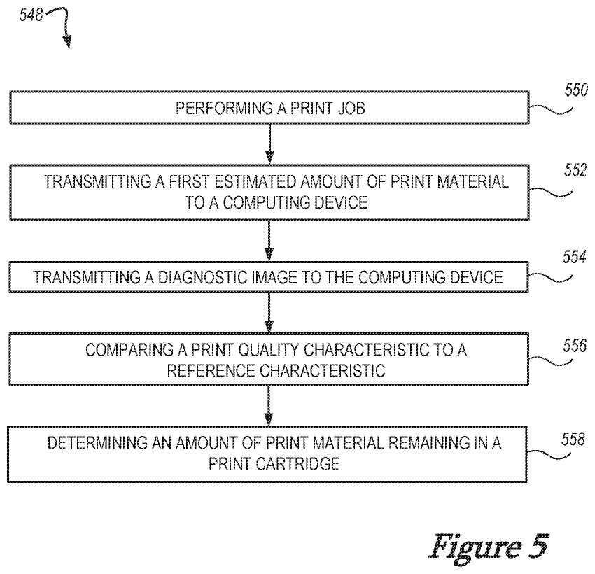

FIG. 5 is an example of a method 548 for print material amounts in print cartridges consistent with the disclosure. The method 548 can be performed by an imaging device (e.g., imaging device 104, previously described in connection with FIG. 1), a mobile device (e.g., mobile device 114, previously described in connection with FIG. 1), and a computing device (e.g., computing device 102, 302, and 402, previously described in connection with FIGS. 1, 3, and 4, respectively).

At 550, the method 548 includes performing, by an imaging device including a print cartridge, a print job. The print job can include printing a print quality characteristic associated with the print cartridge on a print medium and determining a first estimated amount of print material remaining in the print cartridge using pixel counting techniques. The print quality characteristic can include a density level and a line width.

At 552, the method 548 includes transmitting, by the imaging device, the first estimated amount of print material to a computing device. The computing device can be a server operating in a cloud computing environment, among other examples.

At 554, the method 548 includes transmitting, by a mobile device, a diagnostic image to the computing device. The diagnostic image can be a photograph of the print quality characteristic captured by an image capture device of the mobile device.

At 556, the method 548 includes comparing, by the computing device, the print quality characteristic to a reference characteristic of a reference image to determine a second estimated amount of print material remaining in the print cartridge. The reference image can be a photograph taken of the reference characteristic via an image capture device of a mobile device when the print cartridge is new (e.g., full of print material), in some examples. The reference characteristic can include a density level and/or a reference line width. The computing device can compare the density level and/or a line width of the print quality characteristic to the density level and/or reference line width of the reference characteristic. Based on the comparison, the computing device can determine the second estimated amount of print material in the print cartridge.

At 558, the method 548 includes determining an amount of print material remaining in the print cartridge. The computing device can determine the amount of print material remaining in the print cartridge by determining a correction factor using the first estimated amount of print material, the second estimated amount of print material, and imaging device fleet information. For example, the computing device can receive imaging device fleet information from the fleet of imaging devices and determine print material consumption utilizing machine learning techniques from the imaging device fleet information. The computing device can, accordingly, determine the correction factor by determining an error in the first estimated amount of print material by determining a deviation of the first estimated amount of print material from the second estimated amount of print material, as well as compensating utilizing the print material consumption determined from application of machine learning techniques to the imaging device fleet information. The computing device can apply the correction factor to the first estimated amount of print material to determine the amount of print material remaining in the print cartridge.

In the foregoing detailed description of the disclosure, reference is made to the accompanying drawings that form a part hereof, and in which is shown by way of illustration how examples of the disclosure may be practiced. These examples are described in sufficient detail to enable those of ordinary skill in the art to practice the examples of this disclosure, and it is to be understood that other examples may be utilized and that process, electrical, and/or structural changes may be made without departing from the scope of the disclosure. Further, as used herein, “a” can refer to one such thing or more than one such thing.

The figures herein follow a numbering convention in which the first digit corresponds to the drawing figure number and the remaining digits identify an element or component in the drawing. For example, reference numeral 100 may refer to element 102 in FIG. 1 and an analogous element may be identified by reference numeral 302 in FIG. 3. Elements shown in the various figures herein can be added, exchanged, and/or eliminated to provide additional examples of the disclosure. In addition, the proportion and the relative scale of the elements provided in the figures are intended to illustrate the examples of the disclosure, and should not be taken in a limiting sense.

It can be understood that when an element is referred to as being “on,” “connected to”, “coupled to”, or “coupled with” another element, it can be directly on, connected, or coupled with the other element or intervening elements may be present. In contrast, when an object is “directly coupled to” or “directly coupled with” another element it is understood that are no intervening elements (adhesives, screws, other elements) etc.

The above specification, examples and data provide a description of the method and applications, and use of the system and method of the disclosure. Since many examples can be made without departing from the spirit and scope of the system and method of the disclosure, this specification merely sets forth some of the many possible example configurations and implementations.

What is claimed is:

1. A computing device, comprising:
a processing resource; and
a memory resource storing non-transitory machine-readable instructions to cause the processing resource to:
receive a diagnostic image including a print quality characteristic associated with a print cartridge of an imaging device;
compare the print quality characteristic to a reference characteristic of a reference image; and
determine whether an amount of print material in the print cartridge is less than a threshold amount in response to the comparison.

2. The computing device of claim 1, wherein the processing resource is to transmit a permission to the imaging device to allow the print cartridge to be replaced in response to the amount of print material being below a threshold amount.

3. The computing device of claim 1, wherein:
the print quality characteristic on the diagnostic image includes a density level;
the reference characteristic on the reference image includes a density level; and
the processing resource is to compare the density level on the diagnostic image to the density level on the reference image to determine an amount of print material remaining in the print cartridge.

4. The computing device of claim 1, wherein:
the print quality characteristic on the diagnostic image includes a line width;
the reference characteristic on the reference image includes a reference line width; and
the processing resource is to compare the line width on the diagnostic image to the reference line width on the reference image to determine an amount of print material remaining in the print cartridge.

5. The computing device of claim 1, wherein the processing resource is to receive the diagnostic image from a mobile device.

6. The computing device of claim 1, wherein the processing resource is to receive the diagnostic image from the imaging device.

7. A non-transitory machine-readable storage medium including instructions that when executed cause a processing resource to:
receive a diagnostic image including a print quality characteristic associated with a print cartridge of an imaging device;
receive a first estimated amount of print material remaining in the print cartridge from the imaging device;
compare the print quality characteristic to a reference characteristic of a reference image to determine a second estimated amount of print material remaining in the print cartridge; and
determine an amount of print material remaining in the print cartridge based on the first estimated amount of print material and the second estimated amount of print material.

8. The non-transitory storage medium of claim 7, including instructions to determine a correction factor by determining an error in the first estimated amount of print material using the second estimated amount of print material.

9. The non-transitory storage medium of claim 8, including instructions to determine the amount of print material remaining in the print cartridge by applying the correction factor to the first estimated amount of print material.

10. The non-transitory storage medium of claim 9, including instructions to:
determine whether the amount of print material in the print cartridge is less than a threshold amount; and
transmit a permission to the imaging device to allow the print cartridge to be replaced in response to the determined amount of print material being below a threshold amount.

11. A method, comprising:
performing, by an imaging device including a print cartridge, a print job including:
printing a print quality characteristic associated with the print cartridge on a print medium; and
determining a first estimated amount of print material remaining in the print cartridge;
transmitting, by the imaging device, the first estimated amount of print material to a computing device;
transmitting, by a mobile device, a diagnostic image of the print medium including the print quality characteristic to the computing device;
comparing, by the computing device, the print quality characteristic to a reference characteristic of a reference image to determine a second estimated amount of print material remaining in the print cartridge; and
determining; by the computing device, an amount of print material remaining in the print cartridge by:
determining a correction factor using the first estimated amount of print material, the second estimated amount of print material, and imaging device fleet information; and
applying the correction factor to the first estimated amount of print material.

12. The method of claim 11, wherein the method includes determining, by the imaging device; the first estimated amount of print material remaining in the print cartridge via pixel counting.

13. The method of claim 12, wherein the method includes determining, by the computing device; the imaging device fleet information via machine learning using the first estimated amount of print material, the second estimated amount of print material, and imaging device fleet data received from a plurality of imaging devices.

14. The method of claim 11, wherein the method includes:
printing, by the imaging device, a reference characteristic on a reference medium during a reference print job, wherein the reference characteristic corresponds to the print cartridge when the print cartridge is installed in the imaging device: and
transmitting, by the mobile device; the reference image including the reference characteristic to the computing device.

15. The method of claim 11, wherein the method includes performing the print job at a frequency that increases as the amount of print material remaining in the print cartridge decreases.
